(19) United States
(12) Patent Application Publication
(10) Pub. No.: US 2016/0037440 A1
(43) Pub. Date: Feb. 4, 2016

(54) CELL DISCOVERY

(71) Applicant: Microsoft Corporation, Redmond, WA (US)

(72) Inventors: Yuantao Zhang, Beijing (CN); Haitao Li, Beijing (CN)

(21) Appl. No.: 14/503,166

(22) Filed: Sep. 30, 2014

(30) Foreign Application Priority Data
Jul. 31, 2014 (CN) 201410370883.5

(51) Int. Cl. H04W 48/16; H04B 17/318; H04W 36/00; H04W 72/04

(52) U.S. Cl. CPC H04W 48/16; H04W 72/0466; H04B 17/318; H04W 36/0061

(57) ABSTRACT

This disclosure generally relates to cell discovery. In one embodiment, an association between a cell and an indicator index corresponding to one of a set of scrambling sequence indicators may be predefined. A first base station may transmit the set of scrambling sequence indicators to a second base station. The second base station may select an indicator from the indicators according to the predefined association, for generating a reference signal to be transmitted to user equipment. The user equipment may determine identification information of the cell based on the received reference signal and the predefined association, and transmit the identification information to the first base station. In this way, the user equipment may determine the identification information of the cell based on the received reference signal, and then transmit the identification information to the base station, such that the load on the base station may be reduced in the procedure of cell discovery.

### RELATED APPLICATIONS

This application claims priority to Chinese Application No. 201410370883.5, filed on Jul. 31, 2014, and entitled “CELL DISCOVERY” This application claims the benefit of the above-identified application, and the disclosure of the above-identified application is hereby incorporated by reference in its entirety as if set forth herein in full.

### BACKGROUND

In a wireless communication system, a plurality of small cells may be deployed in a blind point or hot point within a macro cell so as to improve system coverage and capacity. As used herein, the term “blind point” refers to a hole of the coverage of the macro cell where no service is able to be provided to user equipment (UE) due to obstacles; and the term “hot point” refers to an area where there are too many traffic needs. Such a small cell may comprise a femtocell, a picocell, a microcell, and the like.

For the purpose of load balancing, power saving and the like, a UE may need to discover small cells surrounding it, and report the discovery result to a base station (BS) of a macro cell, such that the BS may decide which small cell will be turned on and/or turned off Typically, during the procedure of the discovery of a small cell, a UE detects a reference signal from the small cell, obtains information related to the small cell from the reference signal, and reports the information to the BS of the macro cell. As used herein, the term “discovery of a cell” or “cell discovery” refers to a procedure that the UE detects or acquires a cell.

### SUMMARY

In the third Generation Partnership Project (3GPP) Technical Standardization Group (TSG) Radio Access Network 1 (RAN1) meeting, it is proposed that a Channel State Information Reference Signal (CSI-RS) may serve as a reference signal for cell discovery instead of only using a Primary Synchronization Signal/Second Synchronization Signal (PSS/SSS) such that the UE may discover more small cells. However, because the UE cannot obtain identification information, e.g., a cell Identifier (ID), of a small cell from the CSI-RS, the UE may need to transmit information related to the CSI-RS configuration, including, for example, a scrambling sequence and transmission resource of the CSI-RS, to the BS of the macro cell after the UE detects the CSI-RS. Then, the BS of the macro cell may identify the small cell based on the information.

In accordance with embodiments of the subject matter described herein, an association between a cell and an indicator index corresponding to a scrambling sequence indicator from a set of scrambling sequence indicators may be predefined. A first BS may transmit the set of scrambling sequence indicators to a second BS. The second BS may select an indicator from the indicators for generating a reference signal based on the association, and then transmit the generated reference signal to the UE. After receiving the reference signal, the UE may determine identification information of the cell of the second BS based on the reference signal and the association.

In this way, by means of the predefined association between a cell of a BS and an indicator index corresponding to a scrambling sequence indicator from a set of scrambling sequence indicators, the UE may determine the identification information of the cell based on the received reference signal. Furthermore, the UE may transmit the identification information of the cell to a further BS such that the load on the BS may be reduced in the procedure of cell discovery.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 illustrates a block diagram of a UE in accordance with one embodiment of the subject matter described herein;

FIG. 2 illustrates a block diagram of an environment in which embodiments of the subject matter described herein may be implemented;

FIG. 3 illustrates the flowchart of a method for cell discovery at the BS side in accordance with one embodiment of the subject matter described herein;

FIG. 4 illustrates the flowchart of a method for cell discovery at the BS side in accordance with another embodiment of the subject matter described herein;

FIG. 5 illustrates the flowchart of a method for cell discovery at the UE side in accordance with one embodiment of the subject matter described herein;

FIG. 6 illustrates the flowchart of a method for measuring a reference signal received power (RSRP) at the UE in accordance with some embodiments of the subject matter described herein;

FIG. 7 illustrates a block diagram of an apparatus for cell discovery in accordance with one embodiment of the subject matter described herein;

FIG. 8 illustrates a block diagram of an apparatus for cell discovery in accordance with embodiments of the subject matter described herein; and

FIG. 9 illustrates a block diagram of an apparatus for cell discovery in accordance with embodiments of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “base station” (BS) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) refers to any terminal device that is capable of communicating with the BS. By way of example, the UE may include a terminal, a Mobile Terminal (MT), a Subscriber Station (SS), a Portable Subscriber Station (PSS), a Mobile Station (MS), or an Access Terminal (AT).

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

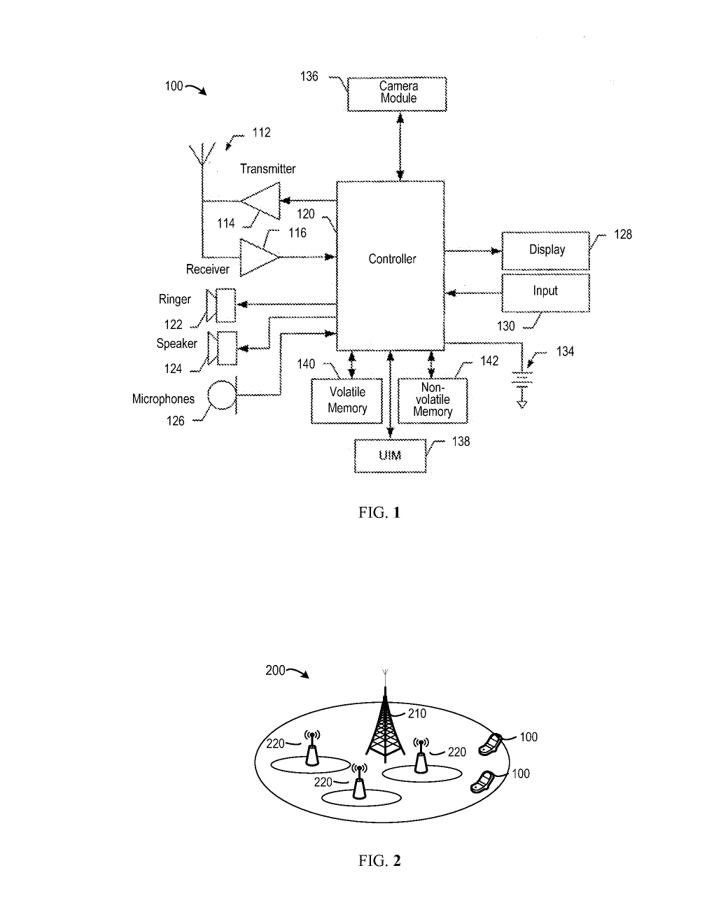

FIG. 1 illustrates a block diagram of a UE 100 in accordance with one embodiment of the subject matter described herein. The UE 100 may be a mobile device with a wireless communication capability. However, it is to be understood that any other types of user devices may also easily adopt embodiments of the subject matter described herein, such as a portable digital assistant (PDA), a pager, a mobile computer, a mobile TV, a game apparatus, a laptop, a tablet computer, a camera, a video camera, a GPS device, and other types of voice and textual communication system. A fixed-type device may likewise easily use embodiments of the subject matter described herein.

As shown, the UE 100 comprises one or more antennas 112 operable to communicate with the transmitter 114 and the receiver 116. The UE 100 further comprises at least one controller 120. It should be understood that the controller 120 comprises circuits or logic required to implement the functions of the user terminal 100. For example, the controller 120 may comprise a digital signal processor, a microprocessor, an A/D converter, a D/A converter, and/or any other suitable circuits. The control and signal processing functions of the UE 100 are allocated in accordance with respective capabilities of these devices.

The UE 100 may further comprise a user interface, which, for example, may comprise a ringer 122, a speaker 124, a microphone 126, a display 128, and an input interface 130, and all of the above devices are coupled to the controller 120. The UE 100 may further comprise a camera module 136 for capturing static and/or dynamic images.

The UE 100 may further comprise a battery 134, such as a vibrating battery set, for supplying power to various circuits required for operating the user terminal 100 and alternatively providing mechanical vibration as detectable output. In one embodiment, the UE 100 may further comprise a user identification module (UIM) 138. The UIM 138 is usually a memory device with a processor built in. The UIM 138 may for example comprise a subscriber identification module (SIM), a universal integrated circuit card (UICC), a universal user identification module (USIM), or a removable user identification module (R-UIM), etc. The UIM 138 may comprise a card connection detecting apparatus according to embodiments of the subject matter described herein.

The UE 100 further comprises a memory. For example, the user terminal 100 may comprise a volatile memory 140, for example, comprising a volatile random access memory (RAM) in a cache area for temporarily storing data. The UE 100 may further comprise other non-volatile memory 142 which may be embedded and/or movable. The non-volatile memory 142 may additionally or alternatively include for example, EEPROM and flash memory, etc. The memory 140 may store any item in the plurality of information segments and data used by the UE 100 so as to implement the functions of the UE 100. For example, the memory may contain machine-executable instructions which, when executed, cause the controller 120 to implement the method described below.

It should be understood that the structural block diagram in FIG. 1 is shown only for illustration purpose, without suggesting any limitations on the scope of the subject matter described herein. In some cases, some devices may be added or reduced as required.

FIG. 2 shows an environment in which embodiments of the subject matter described herein may be implemented. As shown, a system 200 may comprise a macro cell and several small cells within the macro cell. Each of the macro and small cells may have a serving BS. Hereinafter, for the purpose of simplicity, the BS of the macro cell is referred to as a macro BS, and the BS of the small cell is referred to as a small BS. It is to be understood the deployment of the system 200 as shown in FIG. 2 is only for illustration purpose, without suggesting any limitations on the scope of the subject matter described herein. In one embodiment, the system 200 may comprises only macro cells or small cells.

As shown in FIG. 2, one or more UEs 100 may communicate with a macro BS 210 and one or more small BSs 220 in the system 200. In this example, there are two UEs 100, one macro BS 210 and three small BSs 220. These are only for the purpose of illustration without suggesting limitations on the numbers of UEs 100, macro BSs 210 and small BSs 220. There may be any suitable number of UEs 100 in communication with any suitable number of macro BSs 210 and any suitable number of small BSs 220, wherein one macro BS 210 may communication with any suitable number of small BSs 220.

The communications between the UEs 100 and the BSs, including the macro BSs 210 and the small BSs 220 may be implemented via air interface according to any appropriate communication protocols including, but not limited to, the first generation (1G), the second generation (2G), the third generation (3G), the fourth generation (4G) communication protocols, and/or any other protocols either currently known or to be developed in the future. The communication between one macro BS 210 and one or more small BSs 220 may be implemented in a backhaul link, for example, via an interface between BSs, such as an interface X2. The UEs 100 and the BSs 210 and 220 may use any appropriate wireless communication techniques, including, but not limited to, Code Division Multiple Access (CDMA), Frequency Division Multiple Access (FDMA), Time Division Multiple Address (TDMA), Frequency Division Duplex (FDD), Time Division Duplex (TDD), Multiple Input Multiple Output (MIMO), Orthogonal Frequency Division Multiplexing (OFDM), and/or any other technique either currently known or to be developed in the future.

In the example shown in FIG. 2, only for the purpose of illustration, a macro BS 210 allocates a scrambling sequence for a small BS 220. Then, the small BS 220 may use the scrambling sequence to generate a reference signal, and transmit the generated reference signal to the UE 100 for the discovery of the small cell so that the small BS 220 can serve the UE. Herein, the reference signals may include, but are not limited to, synchronization signals, discovery signals, and any other types of reference signals. Traditionally, upon receipt of the reference signal from the small BS 220, the UE 100 may transmit related configuration information of the reference signal to the macro BS 210 such that the macro BS 210 may identify the small cell for subsequent processes, such as load balancing, power saving, and the like.

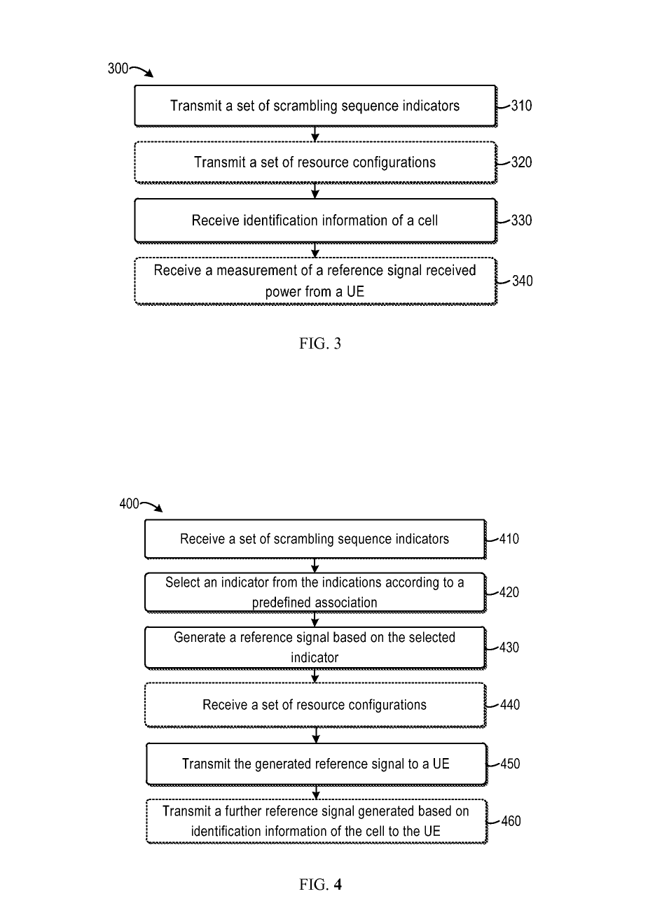

FIG. 3 shows the flowchart of a method 300 for cell discovery at the BS side in accordance with one embodiment of the subject matter described herein. The method 300 may be at least in part implemented by a macro BS 210. This is only for the purpose of illustration without suggesting limitations on the BS. The method 300 may be implemented in any type of BS. For example, the method 300 may also be implemented by a small BS 220.

The method 300 is entered at step 310, where the macro BS 210 transmits a set of scrambling sequence indicators to a further BS. The indicator may be information indicating a scrambling sequence. Each of the scrambling sequence indicators corresponds to an indicator index. The scrambling sequences are to be used to generate reference signals for the discovery of cells. Only for the purpose of illustration, the further BS may be implemented as a small BS 220, and the cell to be discovered may be the small cell of the small BS 220. It is to be understood that the further BS may be any type of BS. For example, the further BS may be a further macro BS, and accordingly the cell in question may be the macro cell of the further macro BS. As discussed above, the indicators may be transmitted via an interface between BSs, such as an interface X2, as described above.

In one embodiment, the set of scrambling sequence indicators may be a superset of the scrambling sequence indicators for all target small cells intended to receive the indicators. For example, the set of scrambling sequence indicators may exactly include the scrambling sequence indicators for the target small cells. Alternatively, the set of scrambling sequence indicators may include all available scrambling sequence indicators. In another embodiment, the set of scrambling sequence indicators may be a limited set from which only a part of the small BSs 220 receiving the indicators may obtain an available scrambling sequence.

According to embodiments of the subject matter described herein, the scrambling sequence indicators may be scrambling sequences themselves or identifiers of the scrambling sequences. If the indicators are the identifiers of the scrambling sequences, the scrambling sequences may be determined based on the identifiers. In one embodiment, the correspondence between the scrambling sequences and the identifiers thereof may be stored locally at the small BS 220. The small BS 220 may obtain the scrambling sequences by means of, for example, a table look-up, based on the received identifiers of the scrambling sequences. In another embodiment, a scrambling sequence is generated based on its identifier according to a specific algorithm. The small BS 220 may calculate the scrambling sequences from the identifiers according to the algorithm.

Upon receipt of the set of scrambling sequence indicators, the small BS 220 may need to know which scrambling sequence indicator is intended to be used by itself to generate a reference signal for the discovery of the small cell. According to embodiments of the subject matter described herein, an association between the small cell of the small BS and an indicator index of a scrambling sequence indicator may be predefined. According to the predefined association, the small BS 220 may find the scrambling sequence indicator for its own small cell from the set of scrambling sequence indicators received from the macro BS 210. The operations of the small BS 220 will be described below with reference to FIG. 4.

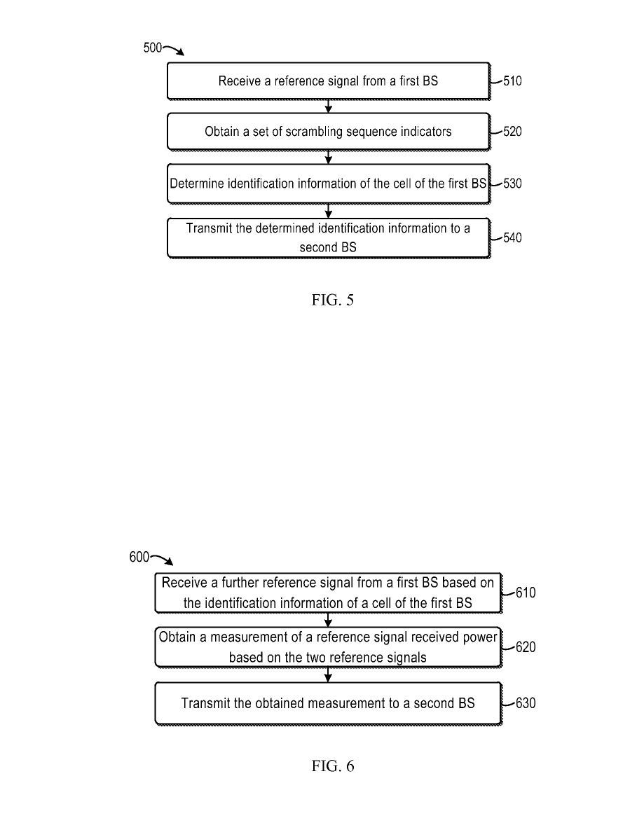

As discussed above, the small BS 220 may transmit the reference signal to the UE 100 such that UE 100 may discover the corresponding small cell. According to embodiments of the subject matter described herein, the UE 100 may also obtain the set of scrambling sequence indicators, and know the predefined association between a small cell and an indicator index of an indicator. Thus, upon receipt of the reference signal, the UE 100 may determine which small cell transmitted the reference signal. The operations of the UE 100 will be described below with reference to FIGS. 5 and 6.

It is to be understood that the association is not constant after being defined, but may be changed according to practical needs. After the association is changed, a new association should be known by the devices, including for example UEs 100 and BSs 220 and 230, within the system 200.

Typically, a scrambling sequence is not of unique correspondence with a small cell due to the limitation of the total number of the sequences. That is, the scrambling sequence indicators corresponding to more than one indicator index may probably be the same. As a result, the UE may not determine a unique small cell based on the predefined association between a small cell and an indicator index of an indicator.

In one embodiment, in order to optimization the result of identifying a small cell by the UE 100, after step 310, the method 300 proceeds to step 320, where the macro BS 210 transmits a set of resource configurations to the small BS 220. Each of the resource configurations corresponds to a configuration index. The resources are to be used to transmit reference signals for the discovery of cells. The resource may be a time and/or frequency resource.

Likewise, upon receipt of the set of resource configurations, the small BS 220 needs to know which resource is intended to be used by itself to transmit the reference signal. In this embodiment, in addition to the association between the small cell of the small BS and an indicator index of a scrambling sequence indicator, a further association between the small cell and a configuration index of a resource configuration may be predefined. According to the further predefined association, the small BS 220 may find the resource for its own small cell from the set of resource configurations received from the macro BS 210. Likewise, the further association is also not constant after being defined, but may be changed according to practical needs. After the further association is changed, a new further association should also be known by the devices, including for example UEs 100 and BSs 220 and 230, within the system 200.

In this embodiment, the UE 100 may obtain the set of resource configurations, and know the predefined association between a small cell and a configuration index of a resource configuration. In this case, upon the reception of the reference signal, the UE 100 may determine which small cell transmitted the reference signal based on the reference signal and the two predefined associations. In this way, the UE 100 may determine a less number of objective small cells based on the received reference signal.

As discussed above, the CSI-RS may serve as the reference signal for cell discovery. In a case where the CSI-RS is used as the reference signal, the scrambling sequence indicator of the CSI-RS may comprise CSI-RS scrambling identifier (ID). As known, a discovery reference signal (DRS) occasion is proposed as a time period for transmission of a discovery reference signal, including, for example, the PSS-SSS, the CSI-RS and a Common Reference Signal (CRS), in a Long Term Evolution (LTE) system. The time and frequency resource configuration of the CSI-RS may comprise a subframe offset of the CSI-RS relative to the PSS/SSS transmitted from the same small cell in the DRS occasion and the Resource Elements (RE) for the CSI-RS. In this case, the UE 100 may identify a small cell based on the received CSI-RS, a first predefined association between the small cell and an index corresponding to one of the CSI-RS scrambling IDs, a second predefined association between the small cell and an index corresponding to one of the subframe offsets of CSI-RSs in the DRS occasion, and a third predefined association between the small cell and an index corresponding to one of the REs for CSI-RSs.

It is to be understood that step 320 is optional. For example, in one embodiment, there are no association between a small cell and a configuration index of a resource configuration. In this embodiment, the macro BS 210 may transmit a specific resource configuration to the small BS 220 in the conventional manner, without transmitting a set of resource configurations to the small BS 220. The UE 100 only utilizes the association between the small cell and the indicator index of the scrambling sequence indicator to identify the small cell.

Still with reference to FIG. 3, the method 300 proceeds to step 330, where the macro BS 210 receives the identification information of the small cell from the UE 100. In this way, the load on the macro BS 210 may be reduced in the procedure of the discovery of the small cell.

Generally, if the macro BS 210 is aware of a level of a reference signal received power (RSRP) of the UE 100, the sequent scheduling may be more efficient. In one embodiment, after step 330, the method 300 proceeds to step 340, where the macro BS 210 receives a measurement of the RSRP from the UE 100. As known, the CRS is generated based on identification information of a cell, such as a cell ID, and is typically used for measuring the RSRP. In order to improve the accuracy of the measurement of the RSRP, the measurement may be obtained by the UE 100 based on the reference signal, such as the CSI-RS, and a further reference signal that is obtained based on the identification information of the small cell, such as the CRS. By use of the two reference signals, the measurement of the reference signal receiving power may be more accurate. It is to be understood that step 340 is optional. For example, in one embodiment, the UE 100 may measure the RSRP only using a reference signal, such as CSI-RS, in the conventional manner.

In this way, the UE 100 may determine the identification information of the small cell based on the reference signal received from the small cell. Furthermore, the UE 100 may transmit the identification information of the cell to the macro BS 220 such that the load on the macro BS 220 may be reduced in the procedure of the discovery of the small cell.

FIG. 4 shows the flowchart of a method 400 for cell discovery at the BS side in accordance with another embodiment of the subject matter described herein. The method 400 may be at least in part implemented by a small BS 220, and the cell to be discovered may be the small cell of the small BS 220. This is only for the purpose of illustration without suggesting limitations on the BS and the cell. The method 400 may be implemented in any type of BS. For example, the method 400 may be implemented by a macro BS 210 for the discovery of the corresponding macro cell.

The method 400 is entered at step 410, where the small BS 220 receives a set of scrambling sequence indicators from a further BS. Each of the scrambling sequence indicators corresponds to an indicator index. One of the scrambling sequences is to be used by the small BS 220 to generate a reference signal for the discovery of its own small cell. Only for the purpose of illustration, the further BS may be implemented as a macro BS 210. It is to be understood that the further BS may be of any suitable type. For example, the further BS may be a further small BS, and accordingly the cell in question may be the small cell of the further mall BS. As discussed above, the indicators may be received via an interface between BSs, such as an interface X2, as described above.

As discussed above with reference to FIG. 3, in one embodiment, the set of scrambling sequence indicators may be a superset of the scrambling sequence indicators for all target small cells intended to receive the indicators. In another embodiment, the set of scrambling sequence indicators may be a limited set from which only a part of the small BSs 220 receiving the information may obtain an available scrambling sequence.

As discussed above with reference to FIG. 3, according to embodiments of the subject matter described herein, the scrambling sequence indicators may be scrambling sequences themselves or identifiers of the scrambling sequences. If the indicators are the identifiers of the scrambling sequences, the scrambling sequences may be determined based on the identifiers.

Still with reference to FIG. 4, the method 400 proceeds to step 420, where the small BS 220 selects an indicator from the set of scrambling sequence indicators according to a predefined association between its own the small cell and an indicator index corresponding to a scrambling sequence indicator after receiving the set of indicators at step 410. Then, the small BS 220 generates, based on the selected scrambling sequence indicator, a reference signal for the discovery of its own small cell at step 430.

Then, the method 400 proceeds to step 450, where the small BS 220 transmits the generated reference signal to the UE 100, such that the UE 100 may discover the small cell. As discussed above with reference to FIG. 3, the UE 100 may also obtain the set of scrambling sequence indicators, and know the predefined association between a small cell and an indicator index of an indicator. In this way, upon the reception the reference signal, the UE 100 may determine the identification information of the small cell transmitting the reference signal.

As discussed above with reference to FIG. 3, in order to optimization the result of identifying a small cell by the UE 100, in one embodiment, the small BS 220 receives a set of resource configurations from the macro BS 210 at step 440 after step 430 in the method 400. Each of the resource configurations corresponds to a configuration index. The resource may be a time and/or frequency resource. In this embodiment, before transmitting the reference signal, the small BS 220 may select a configuration from the set of configurations according to a predefined association between its own small cell and a configuration index corresponding to the configuration.

As discussed above, in this embodiment, the UE 100 may also obtain the set of resource configurations, and know the predefined association between a small cell and an indicator index of a resource configuration. Thus, the UE 100 may determine a less number of small cells from the received reference signal based on the two predefined associations.

It is to be understood that step 440 is optional. For example, in one embodiment, there are no association between a small cell and an indicator index of a resource configuration. In this embodiment, the small BS 220 may receive a specific resource configuration to its own small cell in the conventional manner from the macro BS 210, without receiving a set of resource configurations from the macro BS 210. The UE 100 only utilizes the association between the small cell and the indicator index of the scrambling sequence indicator to identify the small cell.

As discussed above, the two associations are not constant after being defined, but may be changed according to practical needs. After the associations are changed, new associations should be known by the devices, including for example UEs 100 and BSs 220 and 230, within the system 200.

Next, the method 400 proceeds to step 460, where the small BS 220 transmits a further reference signal to the UE 100 such that the UE 100 may measure the RSRP using the two reference signals. The further reference signal is generated based on the identification information of the small cell, such as the CRS. As discussed above, step 460 is optional. For example, in one embodiment, the small BS 220 may not transmit the further reference signal to the UE 100. Accordingly, the UE 100 measures the RSRP only using a reference signal such as the CSI-RS in the conventional manner. The operations in the UE 100 will be described below with reference to FIGS. 5 and 6.

FIG. 5 shows the flowchart of a method 500 for cell discovery at the UE side in accordance with one embodiment of the subject matter described herein. The method 500 may be at least in part implemented by the UE 100.

The method 500 is entered at step 510, where the UE 100 receives a reference signal from a BS. The reference signal is used for discovery of a cell. Only for the purpose of illustration, the BS may be implemented as a small BS 220, and the cell to be discovered may be the small cell of the small BS 220. It is to be understood that the BS may be of any suitable type. For example, the BS may be a macro BS, and accordingly the cell in question may be the macro cell of the macro BS.

Then, the method 500 proceeds to step 520, where the UE 100 obtains a set of scrambling sequence indicators, wherein each of the scrambling sequence indicators corresponds to an indicator index. The set of scrambling sequence indicators may be received in advance from a BS, such as macro BS 210 or small BS 220. As discussed above, the scrambling sequence indicators may be scrambling sequences themselves or identifiers of the scrambling sequences. If the indicators are the identifiers of the scrambling sequences, the scrambling sequences may be determined based on the identifiers.

Next, at step 530, the UE 100 determines identification information of the small cell of the small BS 220. As discussed above, according to embodiments of the subject matter described herein, the determination of the identification information is performed based on the received reference signal and a predefined association between the small cell and an indicator index of a scrambling sequence indicator.

In one embodiment, at step 530, the UE 100 may first determine, from the received reference signal, the scrambling sequence used to generate the reference signal. Then, the UE 100 may determine the identification information of the small cell based on the determined scrambling sequence and the predefined association.

Using the set of scrambling sequence indicators, the operations of the UE 100 on detection of the reference signal and determining of the scrambling sequence may be reduced. For example, the UE 100 may compare the received signals with each of the scrambling sequences determined based on the indicators until their correlation is greater than a predefined threshold. The high correlation indicates a relative high probability that the received signal is a reference signal and that the corresponding scrambling sequence has been used to generate the reference signal. It is to be understood that the UE 100 does not necessarily require the set of scrambling sequence indicators. For example, in one embodiment, it is possible for the UE 100 to detect the reference signal and determine the scramble sequence without such indicators.

As discussed above with reference to FIG. 3, in order to optimization the result of identifying a small cell by the UE 100, in one embodiment, the UE 100 may also obtain the set of resource configurations, and know the predefined association between a small cell and an indicator index of a resource configuration. Thus, the UE 100 may determine a less number of small cells from the received reference signal based on the predefined association between the small cell and an indicator index of a scrambling sequence indicator and the predefined association between the small cell and a configuration index of a resource configuration.

Still with reference to FIG. 5, the method 500 proceeds to step 540, where the UE 100 transmits the determined identification information of the small cell to the macro BS 210. In this way, the load on the macro BS 210 in the procedure of cell discovery may be reduced.

As discussed above, if the macro BS 210 is aware of a level of a RSRP of the UE 100, the subsequent scheduling may be more efficient. In one embodiment, upon the determination of the identification information of the small cell, the UE 100 may measure the RSRP using the reference signal and a further reference signal based on the identification information. In this regard, FIG. 6 illustrates the flowchart of a method 600 for measuring a RSRP at the UE 100 in accordance with some embodiments of the subject matter described herein.

The method 600 is entered at step 610, where the UE 100 receives a further reference signal, such as the CRS, from the small BS 220 based on the identification information. Then, the method 600 proceeds to step 620, where the UE 100 obtains a measurement of the RSRP based on the reference signal, such as CSI-RS, and the further reference signal, such as the CRS. Next, at step 630, the UE 100 transmits the obtained measurement to the macro BS 210. As discussed above, by use of the two reference signals, the RSRP can be measured more accurately.

It is to be understood that the use of the further reference signal for the RSRP measurement as described with reference to FIG. 6 is optional. For example, in one embodiment, the UE 100 may measure the RSRP only using a reference signal such as the CSI-RS in the conventional manner.

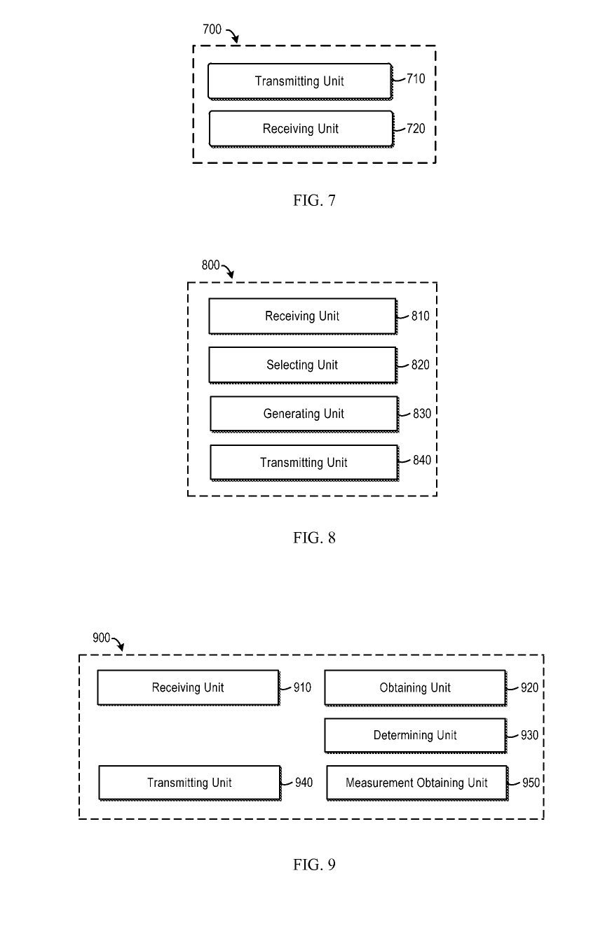

FIG. 7 shows a block diagram of an apparatus 700 for cell discovery implemented at least in part by a BS in accordance with one embodiment of the subject matter described herein. As shown, the apparatus 700 comprises a transmitting unit 710 configured to transmit a set of scrambling sequence indicators to a further BS, such that the further BS selects an indicator from the indicators for generating a reference signal, the indicator selected according to a first association between a cell of the further BS and an indicator index corresponding to the indicator; and a receiving unit 720 configured to receive identification information of the cell from a UE, the identification information obtained by the UE based on the reference signal and the first association.

In one embodiment, the transmitting unit 710 may be further configured to transmit a set of resource configurations to the further BS, such that the further BS selects a configuration from the configurations for transmitting the reference signal, the configuration selected according to a second association between the cell and a configuration index corresponding to the configuration. In this embodiment, the identification information is obtained by the UE based on the reference signal, the first association and the second association:

In one embodiment, the transmitting unit 710 may be further configured to transmit the set of scrambling sequence indicators and/or the set of resource configurations to the UE.

In one embodiment, the receiving unit 720 may be further configured to receive a measurement of a RSRP from the UE, the measurement obtained by the UE based on the reference signal and a further reference signal that is received based on the identification information of the small cell.

FIG. 8 shows a block diagram of an apparatus 800 for cell discovery implemented at least in part by a BS in accordance with embodiments of the subject matter described herein. As shown, the apparatus 800 comprises a receiving unit 810 configured to receive a set of scrambling sequence indicators from a further BS; a selecting unit 820 configured to select an indicator from the indicators according to a first association between a cell of the BS and an indicator index corresponding to the indicator; a generating unit 830 configured to generate the reference signal based on the selected indicator; and a transmitting unit 840 configured to transmit the generated reference signal to a UE.

In one embodiment, the receiving unit 810 may be further configured to receive a set of resource configurations from the further BS. In this embodiment, the selecting unit 820 may be further configured to select a configuration from the configurations according to a second association between the cell and a configuration index corresponding to the configuration. The transmitting unit 840 may be further configured to transmit the reference signal to the UE based on the selected configuration.

In one embodiment, the transmitting unit 840 may be further configured to transmit the set of scrambling sequence indicators and/or the set of resource configurations to the UE.

In one embodiment, the generating unit 830 may be further configured to generate a further reference signal based on identification information of the cell. In this embodiment, the transmitting unit 840 may be further configured to transmit the determined further reference signal to the UE such that the UE obtains a measurement of a RSRP based on the reference signal and the further reference signal.

FIG. 9 shows a block diagram of an apparatus 900 for cell discovery implemented at least in part by a UE in accordance with embodiments of the subject matter described herein. As shown, the apparatus 900 comprises a receiving unit 910 configured to receive a reference signal from a first BS; an obtaining unit 920 configured to obtain a set of scrambling sequence indicators; a determining unit 930 configured to determine identification information of a cell of the first BS based on the received reference signal and a first association between the cell and an indicator index corresponding to one of the indicators; and a transmitting unit 940 configured to transmit the determined identification information to a second BS.

In one embodiment, the determining unit 930 may be further configured to determine the scrambling sequence for the received reference signal, and determine the identification information based on the determined scrambling sequence and the first association.

In one embodiment, the obtaining unit 920 may be further configured to obtain a set of resource configurations. In this embodiment, the determining unit 930 may be further configured to determine the identification information based on the received reference signal, the first association and a second association between the cell and a configuration index corresponding to one of the configurations.

In one embodiment, the determining unit 930 may be further configured to determine a scrambling sequence for the received reference signal, determine a resource for the received reference signal, and determine the identification information based on the determined scrambling sequence and resource and the first and second associations.

In one embodiment, the receiving unit 910 may be further configured to receive the set of scrambling sequence indicators and/or the set of resource configurations from the first or second BS.

In one embodiment, the apparatus 900 may further comprise a measurement obtaining unit 950 configured to obtain a measurement of a RSRP based on the reference signal and a further reference signal. In this embodiment, the receiving unit 910 may be further configured to receive the further reference signal from the first BS based on the identification information. The transmitting unit 940 may be further configured to transmit the obtained measurement to the second BS.

The units included in the apparatuses 700, 800 and 900 may be implemented in various manners, including software, hardware, firmware, or any combination thereof.

In one embodiment, one or more units may be implemented using software and/or firmware, for example, machine-executable instructions stored on the storage medium. In addition to or instead of machine-executable instructions, parts or all of the units in the apparatuses 700, 800 and/or 900 may be implemented, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts discussed above. Rather, the specific features and acts discussed above are disclosed as example forms of implementing the claims.

I/We claim:

1. A method implemented at least in part by a base station, comprising:
transmitting a set of scrambling sequence indicators to a further base station, such that the further base station selects an indicator from the indicators for generating a reference signal, the indicator selected according to a first association between a cell of the further base station and an indicator index corresponding to the indicator; and
receiving identification information of the cell from user equipment, the identification information obtained by the user equipment based on the reference signal and the first association.

2. The method according to claim 1, further comprising:
transmitting a set of resource configurations to the further base station, such that the further base station selects a configuration from the configurations for transmitting the reference signal, the configuration selected according to a second association between the cell and a configuration index corresponding to the configuration.

3. The method according to claim 2, wherein the identification information is obtained by the user equipment based on the reference signal, the first association, and the second association:

4. The method according to claim 1, further comprising:
transmitting the set of scrambling sequence indicators to the user equipment.

5. The method according to claim 2, further comprising:
transmitting the set of resource configurations to the user equipment.

6. The method according to claim 1, further comprising:
receiving a measurement of a reference signal received power from the user equipment, the measurement obtained by the user equipment based on the reference signal and a further reference signal that is received by the user equipment based on the identification information.

7. A method implemented at least in part by a base station, comprising:
receiving a set of scrambling sequence indicators from a further base station;
selecting an indicator from the indicators according to a first association between a cell of the base station and an indicator index corresponding to the indicator;
generating a reference signal based on the selected indicator; and
transmitting the generated reference signal to user equipment.

8. The method according to claim 7, further comprising:
receiving a set of resource configurations from the further base station;
selecting a configuration from the configurations according to a second association between the cell and a configuration index corresponding to the configuration,
wherein transmitting the generated reference signal comprises:
transmits the reference signal to the user equipment based on the selected configuration.

9. The method according to claim 7, further comprising:
transmitting the set of scrambling sequence indicators to the user equipment.

10. The method according to claim 8, further comprising:
transmitting the set of resource configurations to the user equipment.

11. The method according to claim 7, further comprising:
generating a further reference signal based on identification information of the cell; and
transmitting the generated further reference signal to the user equipment such that the user equipment obtains a measurement of a reference signal received power based on the reference signal and the further reference signal.

12. User equipment, comprising:
a receiver configured to receive a reference signal from a first base station;
a controller configured to:
obtain a set of scrambling sequence indicators; and
determine identification information of a cell of the first base station based on the received reference signal and a first association between the cell and an indicator index corresponding to one of the indicators; and
a transmitter configured to transmit the determined identification information to a second base station.

13. The user equipment according to claim 12, wherein the controller is further configured to:
determine a scrambling sequence for the received reference signal; and
determine the identification information based on the determined scrambling sequence and the first association.

14. The user equipment according to claim 12, wherein the controller is further configured to:
obtain a set of resource configurations; and
determine the identification information based on the received reference signal, the first association and a second association between the cell and a configuration index corresponding to one of the configurations.

15. The user equipment according to claim 14 wherein the controller is further configured to:
determine a scrambling sequence for the received reference signal;
determine a resource for the received reference signal; and
determine the identification information based on the determined scrambling sequence and resource and the first and second associations.

16. The user equipment according to claim 12, wherein the receiver is further configured to receive the set of scrambling sequence indicators from the second base station.

17. The user equipment according to claim 12, wherein the receiver is further configured to receive the set of scrambling sequence indicators from the first base station.

18. The user equipment according to claim 14, wherein the receiver is further configured to receive the set of resource configurations from the second base station.

19. The user equipment according to claim 14, wherein the receiver is further configured to receive the set of resource configurations from the first base station.

20. The user equipment according to claim 12, wherein the receiver is further configured to receive a further reference signal from the first base station based on the identification information;
the controller is further configured to obtain a measurement of a reference signal received power based on the reference signal and the further reference signal; and
the transmitter is further configured to transmit the obtained measurement to the second base station.
